(19) United States
(12) Patent Application Publication
(10) Pub. No.: US 2024/0090630 A1
(43) Pub. Date: Mar. 21, 2024

(54) HIKING FISHING POLE

(71) Applicant: Christopher Robert Richey, Sacramento, CA (US)

(72) Inventor: Christopher Robert Richey, Sacramento, CA (US)

(21) Appl. No.: 17/503,079

(22) Filed: Oct. 15, 2021

Related U.S. Application Data
(60) Provisional application No. 63/147,566, filed on Feb. 9, 2021.

(51) Int. Cl. A45B 3/00; A01K 87/00; A45B 9/02; A45B 9/04

(52) U.S. Cl. CPC A45B 3/00; A01K 87/007; A45B 9/02; A45B 9/04; A45B 2009/007

(57) ABSTRACT

A hiking fishing pole is configured to be used for outdoor activities. The hiking fishing pole has a head arranged against a threaded rod and inserted into a first end of a handle. A top tube is arranged inside the handle and connected to a top tube connector with at least one line ring. A middle tube is connected inside the top tube connector with a cam lever. A bottom connector is joined to the middle tube and a bottom tube with a second cam lever and at least one line ring. A basket is joined to the bottom connector and further comprising a line opening.

### RELATED APPLICATION

This application claims priority to provisional patent application U.S. Ser. No. 63/147,566 filed on Feb. 9, 2021, the entire contents of which is herein incorporated by reference.

### BACKGROUND

The embodiments herein relate generally to outdoor recreation.

Prior to embodiments of the disclosed invention there was no device that worked as a hiking pole and a fishing pole. Embodiments of the disclosed invention solve this problem.

### SUMMARY

A hiking fishing pole is configured to be used for outdoor activities. The hiking fishing pole has a head arranged against a threaded rod and inserted into a first end of a handle. A top tube is arranged inside the handle and connected to a top tube connector with at least one line ring. A middle tube is connected inside the top tube connector with a cam lever. A bottom connector is joined to the middle tube and a bottom tube with a second cam lever and at least one line ring. A basket is joined to the bottom connector and further comprising a line opening.

In some embodiments, a reel seat adapter rod is arranged against a reel seat adapter nut and a first real seat. A second reel seat is arranged on the reel seat adapter rod. A reel is joined to the reel seat adapter nut. A line is arranged through the reel and the line opening. A line is arranged through the reel and the line opening.

### BRIEF DESCRIPTION OF THE FIGURES

The detailed description of some embodiments of the invention is made below with reference to the accompanying figures, wherein like numerals represent corresponding parts of the figures.

FIG. 1 shows a perspective view of one embodiment of the present invention, shown in use;

FIG. 2 shows a perspective view of one embodiment of the present invention, shown in use;

FIG. 3 shows a detail view of one embodiment of the present invention;

FIG. 4 shows an assembly view of one embodiment of the present invention;

FIG. 5 shows a section view of one embodiment of the present invention taken along line 5-5 in FIG. 3;

FIG. 6 shows a section view of one embodiment of the present invention;

FIG. 7 shows a section view of one embodiment of the present invention taken along line 7-7 in FIG. 3; and

FIG. 8 shows a section view of one embodiment of the present invention taken along line 8-8 in FIG. 3.

### DETAILED DESCRIPTION OF CERTAIN EMBODIMENTS

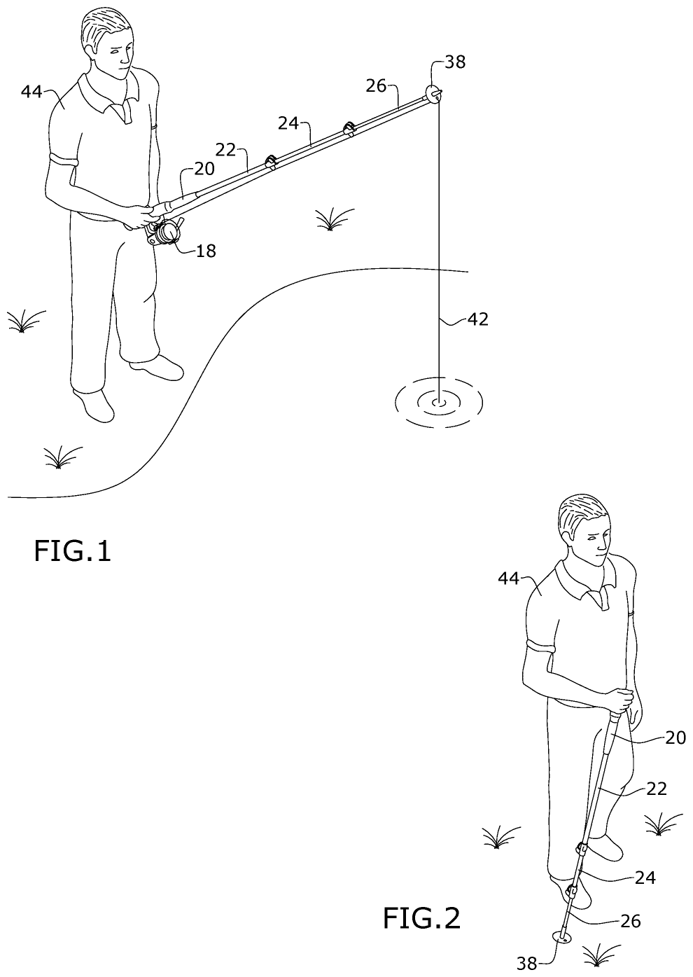

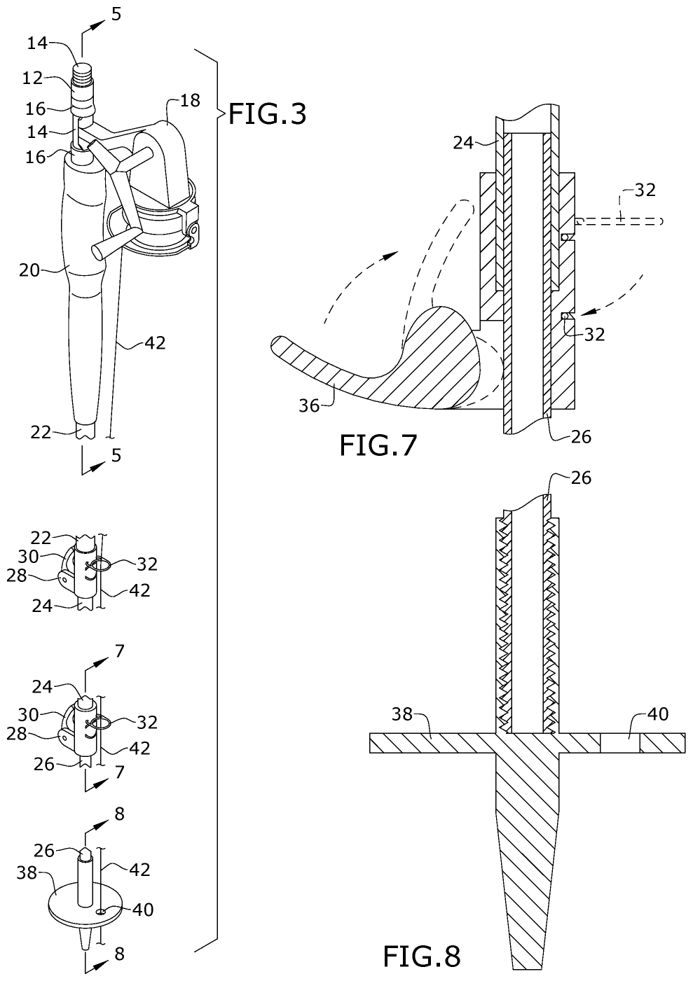

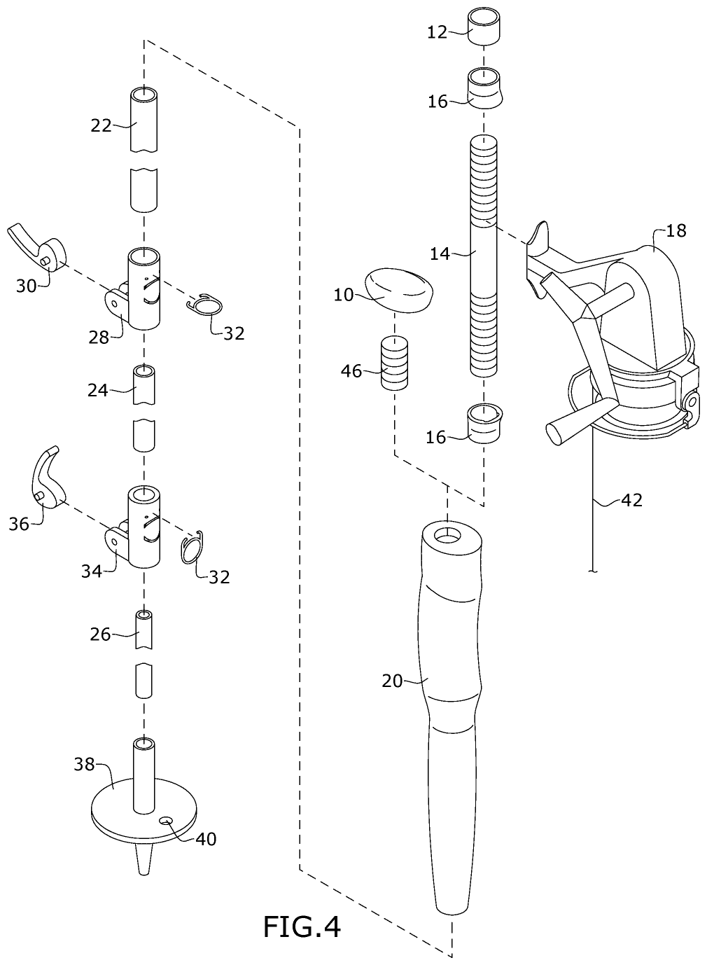

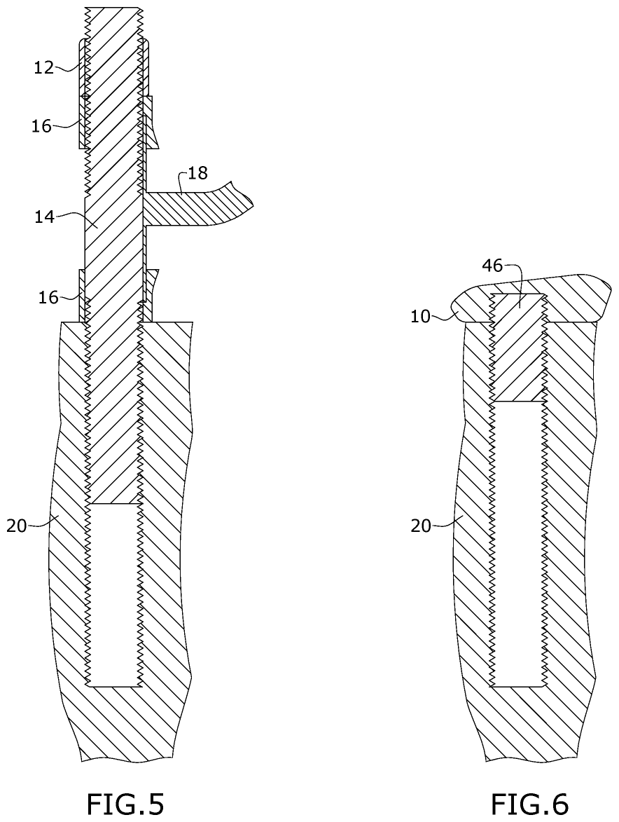

By way of example, and referring to FIGS. 1-8, one embodiment of a hiking fishing pole is configured to be used for outdoor activities such as hiking and fishing. The hiking fishing pole has a handle 20 further comprising a first threaded end and a second end. A top tube 22 is arranged inside the handle 20 and connected to a top tube connector 28 with at least one line ring 32. A middle tube 24 is connected inside the top tube connector 28 with a cam lever 30. A bottom connector 34 is joined to the middle tube 24 and a bottom tube 26 with a second cam lever 30 and at least one line ring 32. A basket 38 is joined to the bottom connector 34 and further comprises a line opening 40.

In a first mode of operation, a head 10 is arranged against a threaded rod 46 is threaded into the first threaded end of the handle 20. The head 10 permits the hiking fishing pole to be used as a hiking pole.

In a second mode of operation, a reel seat adapter rod 14 is arranged against a reel seat adapter nut 12 and a first real seat 16. A second reel seat 16 is arranged on the reel seat adapter rod 14. A reel 18 is joined to the reel seat adapter nut 12. The reel 18 permits the hiking fishing pole to operate as a fishing pole.

In some embodiments, a line 42 arranged through the reel 18 and the line opening 40.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, 116. In particular, any use of “step of” in the claims is not intended to invoke the provision of 35 U.S.C. § 112, 116.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A hiking fishing pole, configured to be used for outdoor activities wherein the hiking fishing pole comprising:
a handle further comprising a first threaded end and a second end; a top tube, arranged inside the handle and connected to a top tube connector with at least one line ring;
a middle tube, connected extendably inside the top tube connector with a cam lever, wherein the middle tube is extendable from the top tube;
a bottom connector with a second cam lever and at least one line ring joined to the middle tube; and
a bottom tube extendably inside the middle tube, wherein the bottom tube is extendable from the middle tube;
a basket, joined to the bottom tube and further comprising a line opening;
a reel seat adapter rod, arranged against a reel seat adapter nut and a first reel seat;
a second reel seat, arranged on the reel seat adapter rod,
a reel joined to the reel seat adapter nut; and
a line arranged through the reel and the line opening, wherein the reel permits the hiking fishing pole to operate as a fishing pole.

2. The hiking fishing pole, of claim 1, further comprising a head arranged against a threaded rod and threaded into the first threaded end; wherein the head permits the hiking fishing pole to be used as a hiking pole.

3-4. (canceled)
